(19) United States
(12) Patent Application Publication
(10) Pub. No.: US 2026/0103176 A1
(43) Pub. Date: Apr. 16, 2026

(54) ELECTRONIC HYDRAULIC BRAKE DEVICES

(71) Applicant: HYUNDAI MOBIS CO., LTD., Seoul (KR)

(72) Inventors: Ji Ho YOO, Yongin-si (KR); Sang Mok LEE, Yongin-si (KR); Si Woo PARK, Yongin-si (KR)

(73) Assignee: HYUNDAI MOBIS CO., LTD., Seoul (KR)

(21) Appl. No.: 19/327,434

(22) Filed: Sep. 12, 2025

(30) Foreign Application Priority Data
Oct. 11, 2024 (KR) 10-2024-0138547

(51) Int. Cl. B60T 13/66; B60T 8/40

(52) U.S. Cl. CPC B60T 13/662; B60T 8/4086; B60T 2270/402

(57) ABSTRACT

A electronic hydraulic brake device includes a storage part that includes a first storage chamber and a second storage chamber and stores braking fluid, a backup part that includes a first backup chamber and a second backup chamber, is engaged to a pedal and is pressurized by the pedal, a main brake part that includes a first brake chamber and a second brake chamber, is engaged to a motor and is driven by the motor to provide the braking fluid, a wheel cylinder part that provides braking force by the supplied braking fluid, and a line part that connects the storage part, the backup part, the main brake part, and the wheel cylinder part and guides the braking fluid, and in an emergency braking situation, the braking fluid of the backup part pressurized by the pedal is supplied to the wheel cylinder part before the braking fluid is pressurized by the main brake part.

### CROSS-REFERENCE TO RELATED APPLICATION

This application claims the benefit under 35 U.S.C. § 119(a) of priority to Korean Patent Application No. 10-2024-0138547 filed on Oct. 11, 2024, in the Korean Intellectual Property Office, the entire disclosure of which is incorporated herein by reference for all purposes.

### BACKGROUND

### 1. Technical Field

Exemplary embodiments of the present disclosure relate to electronic hydraulic brake devices, and more particularly, to electronic hydraulic brake devices that utilize the pedal effort of a driver in an emergency braking situation to improve braking responsiveness and reduce the braking distance of the vehicle to promote the safety of the vehicle.

### 2. Related Art

Generally, an electronic hydraulic brake device senses the driver's pedal pressure through a sensor and controls the braking pressure of each wheel through the hydraulic pressure of a master cylinder driven by a motor.

The electronic hydraulic brake device includes a sensor that senses pedal stroke so that a driver can know desired braking pressure. In addition, the electronic hydraulic brake device includes a pedal travel simulator that allows the driver to feel the same pedal pressure as a general hydraulic brake system.

Therefore, when the driver presses the brake pedal, an electronic control unit senses the driver's brake pedal pressure and supplies braking hydraulic pressure to a master cylinder. Then, the master cylinder transmits braking hydraulic pressure to a wheel cylinder of each wheel, providing braking power to each wheel.

The conventional electronic hydraulic brake devices have the problem that the response speed of the master cylinder driven by a motor is slow in an emergency braking situation, which reduces the responsiveness and increases the braking distance, which causes a vehicle accident. Therefore, there is a need to improve this.

The background technology of the present disclosure is disclosed in Korean Patent Application Publication No. 10-2007-0104982 (published on Oct. 30, 2007, entitled “VALVE CONTROL UNIT FOR ELECTRONIC HYDRAULIC BRAKE SYSTEM”).

### SUMMARY

Various embodiments of the present disclosure are directed to electronic hydraulic brake devices that utilize the pedal effort of a driver in an emergency braking situation to improve braking responsiveness and reduce the braking distance of the vehicle to promote the safety of the vehicle.

In an embodiment of the present disclosure, an electronic hydraulic brake device may include a first storage chamber and a second storage chamber and stores braking fluid, a backup part that includes a first backup chamber and a second backup chamber, is engaged to a pedal and is pressurized by the pedal, a main brake part that includes a first brake chamber and a second brake chamber, is engaged to a motor and is driven by the motor to provide the braking fluid, a wheel cylinder part that provides braking force by the supplied braking fluid, and a line part that connects the storage part, the backup part, the main brake part, and the wheel cylinder part and guides the braking fluid, and in an emergency braking situation, the braking fluid of the backup part pressurized by the pedal is supplied to the wheel cylinder part before the braking fluid is pressurized by the main brake part.

The line part may include a first line part that connects the second storage chamber and the second backup chamber, a second line part that connects the second backup chamber and the second brake chamber, a third line part that connects the first storage chamber and the first brake chamber, a fourth line part that connects the storage part and the wheel cylinder part, a fifth line part that connects the first brake chamber and the wheel cylinder part, and a sixth line part that connects the second brake chamber and the wheel cylinder part.

The first line part may include a first flow path that connects the second storage chamber and the second backup chamber, and a first valve unit that is disposed in the first flow path and configured to open and close the first flow path.

The second line part may include a second flow path that connects the second backup chamber and the second brake chamber, a second opening/closing valve unit that is disposed in the second flow path and opens and closes the second flow path, and a second check valve unit that is disposed in the second opening/closing valve unit and passes the braking fluid of a set pressure or higher.

The third line part may include a third flow path that connects the first backup chamber and the first brake chamber, and a third valve unit disposed in the third flow path and opens and closes the third flow path.

The fifth line part may include a fifth flow path that connects the first brake chamber and the wheel cylinder part, and a fifth valve unit that is disposed in the fifth flow path and opens and closes the fifth flow path.

The sixth line part may include a sixth flow path that connects the second brake chamber and the wheel cylinder part, and a sixth valve unit that is disposed in the sixth flow path and opens and closes the sixth flow path.

The first valve unit may be a normally open valve, and the second opening/closing valve unit and the third valve unit may be normally closed valves.

When the pressure of the braking fluid pressurized by the pedal is greater than or equal to the pressure of the braking fluid moving in the fifth line part, the first valve unit may close the first flow path, the second opening/closing valve unit may open the second flow path, and the third valve unit may open the third flow path.

When the pressure of the braking fluid pressurized by the pedal is lower than the pressure of the braking fluid moving in the fifth line part, the first valve section may open the first flow path, the second opening/closing valve unit may close the second flow path, and the third valve unit may close the third flow path.

The first valve unit may be a normally closed valve, and the second valve unit and the third valve unit may be normally open valves.

When the pressure of the braking fluid pressurized by the pedal is greater than or equal to the pressure of the braking fluid moving in the fifth line part, the first valve unit may close the first flow path, the second opening/closing valve unit may open the second flow path, and the third valve unit may open the third flow path.

When the pressure of the braking fluid pressurized by the pedal is lower than the pressure of the braking fluid moving in the fifth line part, the first valve unit may open the first flow path, the second opening/closing valve unit may close the second flow path, and the third valve unit may close the third flow path.

The electronic hydraulic brake device may further include a block part in which the backup part and the main brake part are settled and the line part is disposed to guide the braking fluid.

The block part may include a block body, a backup bore disposed in the block body and including an installation space for the backup part, and a main brake bore disposed in the block body and including an installation space for the main brake part.

In the electric hydraulic brake device according to the present disclosure, in a normal braking situation, the backup part provides the pedal effort, and the main brake part is driven to correspond to the pedal effort so that the braking fluid can be supplied to the wheel cylinder part.

In the electric hydraulic brake device according to the present disclosure, because the pressure of the braking fluid pressurized by the pedal in an emergency braking situation is higher than the pressure of the braking fluid pressurized by the driving of the main brake part, the braking fluid pressurized by the pedal can be first supplied to the wheel cylinder part. Accordingly, braking responsiveness can be improved, thereby reducing a braking distance.

### BRIEF DESCRIPTION OF THE DRAWINGS

FIG. 1 is a block diagram schematically illustrating an electronic hydraulic brake device according to an embodiment of the present disclosure.

FIG. 2 is a circuit diagram schematically illustrating an electronic hydraulic brake device according to a first embodiment of the present disclosure.

FIG. 3 illustrates the movement of braking fluid during normal braking in FIG. 2.

FIG. 4 illustrates the movement of braking fluid during emergency braking in FIG. 2.

FIG. 5 is a circuit diagram schematically illustrating an electronic hydraulic brake device according to a second embodiment of the present disclosure.

FIG. 6 illustrates the movement of braking fluid during normal braking in FIG. 5.

FIG. 7 illustrates the movement of braking fluid during emergency braking in FIG. 5.

FIG. 8 is a perspective view schematically illustrating a block part according to an embodiment of the present disclosure.

FIG. 9 is a side view schematically illustrating a block part according to an embodiment of the present disclosure.

FIG. 10 schematically illustrates a backup flow path according to an embodiment of the present disclosure.

FIG. 11 schematically illustrates a main braking flow path according to an embodiment of the present disclosure.

### DETAILED DESCRIPTION

Hereinafter, electronic hydraulic brake devices according to the present disclosure are described in detail below with reference to the accompanying drawings through various exemplary embodiments. It should be considered that the thickness of each line or the size of each component in the drawings may be exaggeratedly illustrated for clarity and convenience of description.

In addition, terms to be described below have been defined by taking into consideration their functions in the present disclosure, and may be different depending on a user or operator's intention or practice. Accordingly, such terms should be interpreted based on the overall contents of this specification.

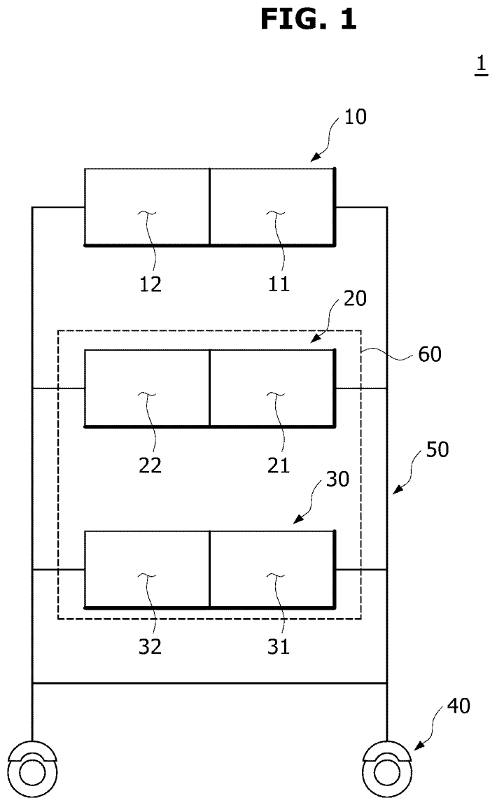

FIG. 1 is a block diagram schematically illustrating an electronic hydraulic brake device according to an embodiment of the present disclosure. Referring to FIG. 1, the electronic hydraulic brake device 1 according to an embodiment of the present disclosure includes a storage part 10, a backup part 20, a main braking part 30, a wheel cylinder part 40, and a line part 50.

The storage part 10 includes a first storage chamber 11 and a second storage chamber 12 so that braking fluid can be stored. The storage part 10 is connected to the backup part 20 and supplies a braking fluid to the backup part 20. The storage part 10 is connected to the wheel cylinder part 40 to recover the braking fluid.

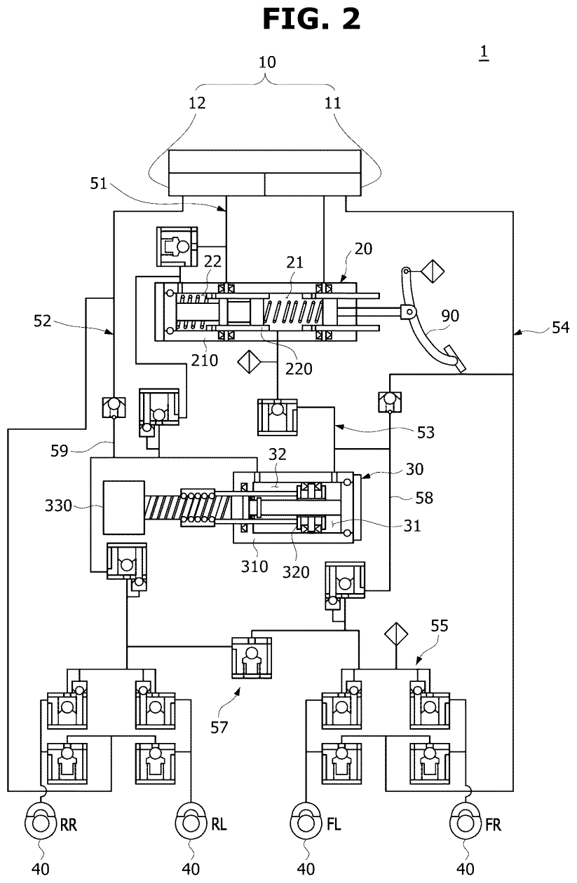

The backup part 20 includes a first backup chamber 21 and a second backup chamber 22, and may be pressurized by a pedal, for example, a pedal 90 in FIG. 2. For example, the backup part 20 may include a backup housing unit, for example, a backup housing unit 210 in FIG. 2 and a backup compartment unit, for example, a backup compartment unit 220 in FIG. 2, which divides an internal space of the backup housing unit 210 into the first backup chamber 21 and the second backup chamber 22. The first backup chamber 21 is connected to the first storage chamber 11, and the second backup chamber 22 is connected to the second storage chamber 12.

The main braking part 30 includes a first brake chamber 31 and a second brake chamber 32, and a motor, for example, a motor 330 in FIG. 2 may be driven to provide a braking fluid. For example, as shown in FIG. 2, the main braking part 30 may include a brake housing part 310 and a brake compartment part 320 that divides the internal space of the brake housing part 310 into the first brake chamber 31 and the second brake chamber 32, and when the brake compartment part 320 is reciprocally moved by the motor 330, the pressure of the braking fluid stored in the first brake chamber 31 and the second brake chamber 32 may be increased. The first brake chamber 31 is connected to the first backup chamber 21, and the second brake chamber 32 is connected to the second backup chamber 22.

The wheel cylinder part 40 may provide braking force to the wheels due to the supplied braking fluid. For example, the wheel cylinder part 40 may be mounted on each wheel of the vehicle.

The line part 50 connects the storage part 10, the backup part 20, the main braking part 30, and the wheel cylinder part 40 to guide the braking fluid.

The electronic hydraulic brake device 1 according to an embodiment of the present disclosure further includes a block part 60. The block part 60 includes the backup part 20 and the main brake part 30, and the line part 50 is disposed to guide the braking fluid. For example, the regions hole-machined in the block part 60 may be the backup housing unit 210 or the brake housing part 310. The line part 50 forms flow paths by hole machining the block part 60 and valves are provided in the flow paths to control the braking fluid. A part of the line part 50 may become a hose that is connected to the wheel cylinder part 40 and guides the braking fluid.

In an emergency braking situation, the braking fluid pressurized in the backup part 20 by the pedal 90 may be supplied to the wheel cylinder part 40 before the braking fluid pressurized in the main braking part 30. The emergency braking situation may be a case where the driver presses the pedal 90 strongly and urgently, and the pressure of the braking fluid stored inside the backup part 20 is higher than the pressure of the braking fluid moving along the line part 50 connecting the main braking part 30 and the wheel cylinder part 40. Additionally, the emergency braking situation may be a case where the pedal 90 is pressurized at a speed higher than a set speed. The set speed may be 450 mm/s. In a normal state, the braking fluid pressurized by the pedal 90 may provide pedal effort and may be moved to the storage part 10. However, in the emergency braking situation, the braking fluid pressurized by the backup part 20 may be supplied to the wheel cylinder part 40 before the braking fluid provided by the main braking part 30 is pressurized.

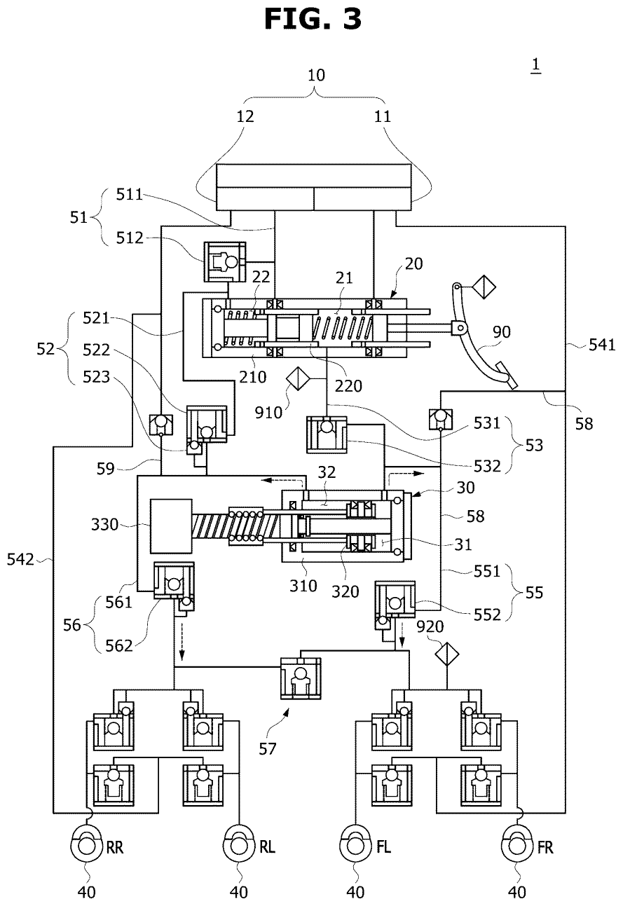

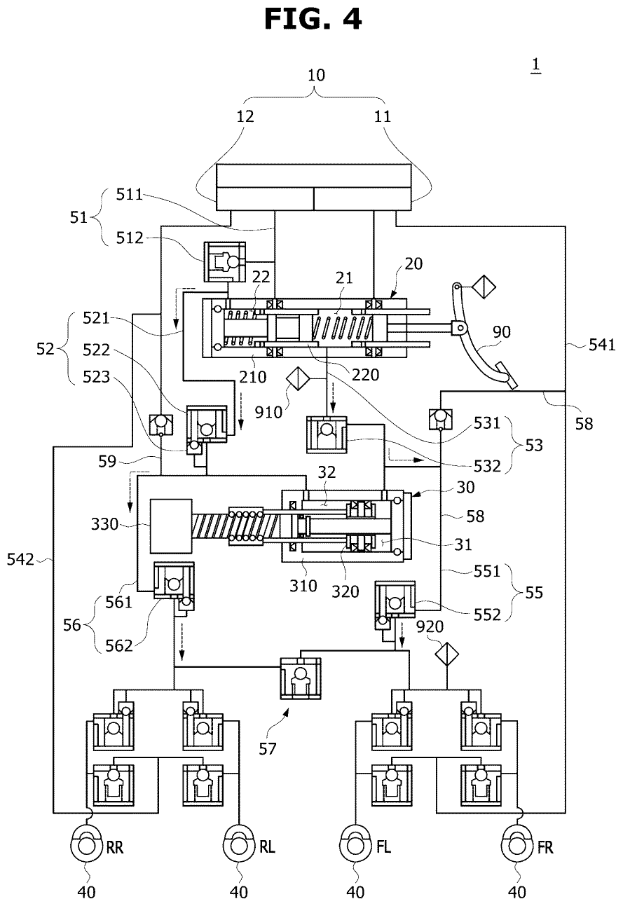

FIG. 2 is a circuit diagram schematically illustrating an electronic hydraulic brake device 1 according to a first embodiment of the present disclosure. FIG. 3 illustrates the movement of a braking fluid during normal braking in FIG. 2. FIG. 4 illustrates the movement of the braking fluid during emergency braking in FIG. 2. Referring to FIG. 2 to FIG. 4, a line part, for example, the line part 50 in FIG. 1 according to a first embodiment of the present disclosure may include a first line part 51, a second line part 52, a third line part 53, a fourth line part 54, a fifth line part 55, and a sixth line part 56.

The first line part 51 connects a second storage chamber 12 and a second backup chamber 22. The first line part 51 includes a first flow path 511 and a first valve unit 512. The first flow path 511 connects the second storage chamber 12 and the second backup chamber 22. One end of the first flow path 511 is connected to the second storage chamber 12, and the other end of the first flow path 511 is connected to the second backup chamber 22. The first flow path 511 is branched and connected to the backup housing unit 210. The first valve unit 512 is disposed in the first flow path 511 and may open and close the first flow path 511.

The second line part 52 connects the second backup chamber 22 and the second brake chamber 32. The second line part 52 includes a second flow path 521, a second opening/closing valve unit 522, and a second check valve unit 523. The second flow path 521 connects the second backup chamber 22 and the second brake chamber 32. The second flow path 521 may be directly connected to the second backup chamber 22 or may be connected to the first flow path 511 that connects the first valve unit 512 and the second backup chamber 22. The second opening/closing valve unit 522 is disposed in the second flow path 521 and opens and closes the second flow path 521. The second check valve unit 523 is disposed in the second opening/closing valve unit 522 and passes a braking fluid of a pressure higher than a set pressure. The second opening/closing valve unit 522 is disposed in the second flow path 521, and the braking fluid of the set pressure or higher may be induced to bypass the second opening/closing valve unit 522.

The third line part 53 connects the first backup chamber 21 and the first brake chamber 31. The third line part 53 includes a third flow path 531 and a third valve unit 532. The third flow path 531 connects the first backup chamber 21 and the first brake chamber 31. The third valve unit is disposed in the third flow path 531 and opens and closes the third flow path 531. A pedal pressure sensor 910 is provided in the third flow path 531 connecting the first backup chamber 21 and the third valve unit 532 to measure the pressure of the braking fluid pressurized by the pedal 90.

The fourth line part 54 connects the storage part 10 and the wheel cylinder part 40. The fourth line part 54 recovers the braking fluid of the wheel cylinder part 40 to the storage part 10. The fourth line part 54 includes a first recovery flow path 541 connecting the first storage chamber 11 and the fifth line part 55, and a second recovery flow path 542 connecting the second storage chamber 12 and the sixth line part 56.

The fifth line part 55 connects the first brake chamber 31 and the wheel cylinder part 40. The fifth line part 55 includes a fifth flow path 551 and a fifth valve unit 552. The fifth flow path 551 connects the first brake chamber 31 and the wheel cylinder part 40. The fifth flow path 551 may be directly connected to the first brake chamber 31 or connected to the third flow path 531 that connects the third valve unit 532 and the first brake chamber 31. The fifth valve unit 552 is disposed in the fifth flow path 551 and opens and closes the fifth flow path 551. The fifth flow path 551 is branched and connected to two wheel cylinder parts 40, and one or more fifth valve units 552 control the braking fluid. A fluid pressure sensor 920 that measures the pressure of the braking fluid may be provided in the fifth flow path 551 connecting the plurality of fifth valve units 552.

The sixth line part 56 connects the second brake chamber 32 and the wheel cylinder part 40. The sixth line part 56 includes a sixth flow path 561 and a sixth valve unit 562. The sixth flow path 561 connects the second brake chamber 32 and the wheel cylinder part 40. The sixth flow path 561 may be directly connected to the second brake chamber 32 or may be connected to the second flow path 521 that connects the second opening/closing valve unit 522 and the second brake chamber 32. The sixth valve unit 562 is disposed in the sixth flow path 561 and opens/closes the sixth flow path 561. The sixth flow path 561 is branched and connected to the two wheel cylinder parts 40, and one or more sixth valve units 562 control the braking fluid.

In addition, the seventh line part 57 selectively connects the fifth line part 55 and the sixth line part 56. The eighth line part 58 connects the first recovery flow path 541 and the fifth flow path 551, and the ninth line part 59 connects the second recovery flow path 542 and the sixth flow path 561.

In the first embodiment of the present disclosure, the first valve unit 512 may be a normally open valve, and the second opening/closing valve unit 522 and the third valve unit 532 may be normally closed valves. That is, when the brake system is normally operated, when no separate control signal is transmitted, the first valve unit 512 may maintain the first flow path 511 in an open state. In addition, the second opening/closing valve unit 522 and the third valve unit 532 may maintain the second flow path 521 and the third flow path 531 in closed states, respectively (refer to FIG. 2).

When the pressure of the braking fluid pressurized by the pedal 90 is greater than or equal to the pressure of the braking fluid moved in the fifth line part 55, emergency braking mode may be implemented. In addition, the emergency braking situation means that the pedal 90 is pressurized at a set speed or more. The set speed may be 450 mm/s. The pressure of the braking fluid pressurized by the pedal 90 may be measured by the pedal pressure sensor 910. The pressure of the braking fluid moved through the fifth line part 55 may be measured by the fluid pressure sensor 920.

In the emergency braking mode, the first valve unit 512 closes the first flow path 511, the second opening/closing valve unit 522 opens the second flow path 521, and the third valve unit 532 opens the third flow path 531. Accordingly, the braking fluid pressurized in the first backup chamber 21 sequentially passes through the third flow path 531 and the fifth flow path 551 to reach the wheel cylinder parts 40. In addition, the braking fluid pressurized in the second backup chamber 22 sequentially passes through the second flow path 521 and the sixth flow path 561 to reach the wheel cylinder parts 40 (refer to FIG. 4).

In the emergency braking mode, when the pressure of the braking fluid pressurized by the pedal 90 is lower than the pressure of the braking fluid moved through the fifth line part 55, the emergency braking mode may be switched to a normal braking mode. In the normal braking mode, the first valve unit 512 may be switched to open the first flow path 511 by a control signal. The second valve unit 522 and the third valve unit 532 may be switched to close the second flow path 521 and the third flow path 531, respectively, by a control signal (refer to FIG. 3).

That is, in the first embodiment, control can be performed on the first valve unit 512, the second opening/closing valve unit 522, and the third valve unit 532 in the emergency braking mode.

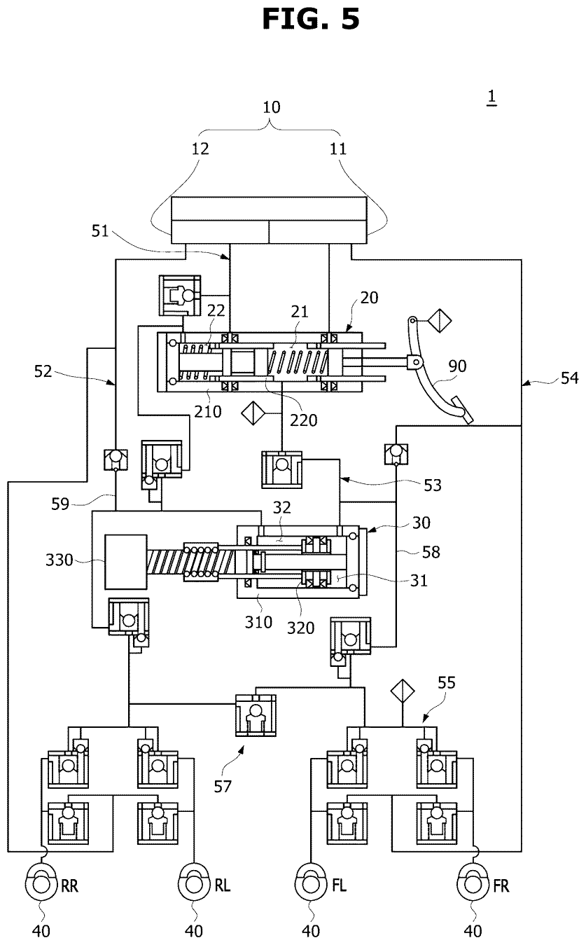

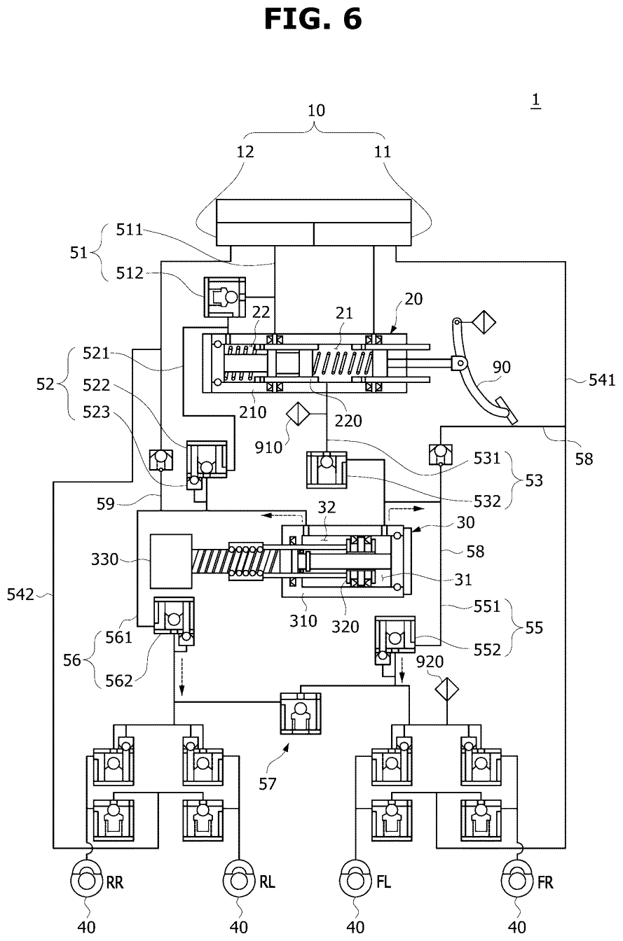

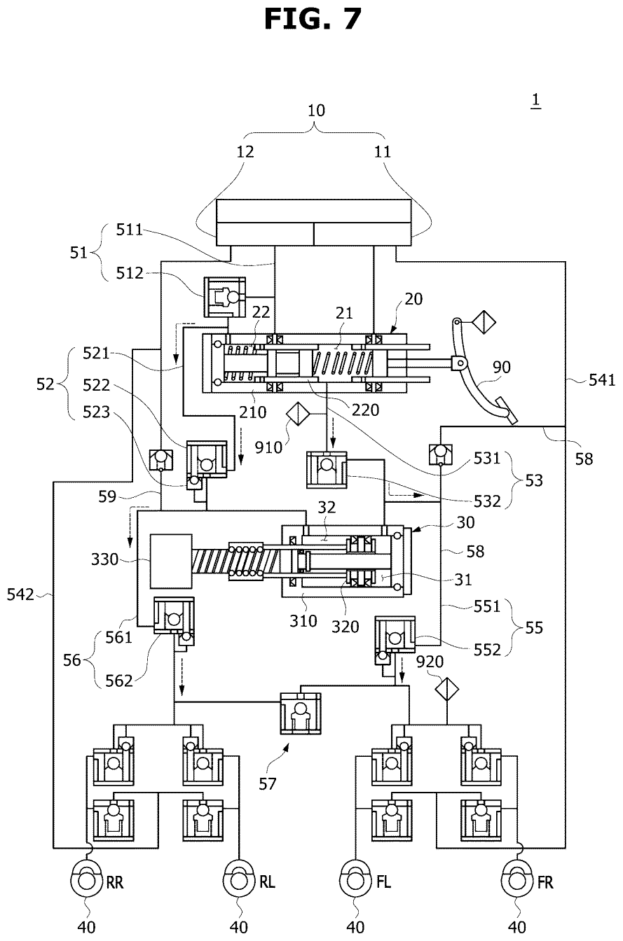

FIG. 5 is a circuit diagram schematically illustrating an electronic hydraulic brake device according to a second embodiment of the present disclosure. FIG. 6 illustrates the movement of braking fluid during normal braking in FIG. 5. FIG. 7 illustrates the movement of the braking fluid during emergency braking in FIG. 5. Referring to FIG. 5 to FIG. 7, a line part 50 according to a second embodiment of the present disclosure includes a first line part 51, a second line part 52, a third line part 53, a fourth line part 54, a fifth line part 55, and a sixth line part 56.

The first line part 51 connects a second storage chamber 12 and a second backup chamber 22. The first line part 51 includes a first flow path 511 and a first valve unit 512. The first flow path 511 connects the second storage chamber 12 and the second backup chamber 22. One end of the first flow path 511 is connected to the second storage chamber 12, and the other end of the first flow path 511 is connected to the second backup chamber 22. The first flow path 511 is branched and connected to a backup housing unit 210. The first valve unit 512 is disposed in the first flow path 511 and opens and closes the first flow path 511.

The second line part 52 connects the second backup chamber 22 and a second brake chamber 32. The second line part 52 includes a second flow path 521, a second opening/closing valve unit 522, and a second check valve unit 523. The second flow path 521 connects the second backup chamber 22 and the second brake chamber 32. The second flow path 521 may be directly connected to the second backup chamber 22, or may be connected to the first flow path 511 connecting the first valve unit 512 and the second backup chamber 22. The second opening/closing valve unit 522 is disposed in the second flow path 521 and opens/closes the second flow path 521. The second check valve unit 523 is disposed in the second opening/closing valve unit 522 and allows the braking fluid of a pressure higher than a set pressure to pass. The second opening/closing valve unit 522 is disposed in the second flow path 521 and induces the braking fluid of a pressure higher than the set pressure to bypass the second opening/closing valve unit 522.

The third line part 53 connects the first backup chamber 21 and the first brake chamber 31. The third line part 53 includes a third flow path 531 and a third valve unit 532. The third flow path 531 connects the first backup chamber 21 and the first brake chamber 31. The third valve unit 532 is disposed in the third flow path 531 and opens and closes the third flow path 531. The third flow path 531 connecting the first backup chamber 21 and the third valve unit 532 is provided with a pedal pressure sensor 910 to measure the pressure of the braking fluid pressurized by the pedal 90.

The fourth line part 54 connects a storage part 10 and a wheel cylinder part 40. The fourth line part 54 recovers the braking fluid of the wheel cylinder part 40 to the storage part 10. The fourth line part 54 includes a first recovery flow path 541 connecting a first storage chamber 11 and the fifth line part 55, and a second recovery flow path 542 connecting a second storage chamber 12 and the sixth line part 56.

The fifth line part 55 connects the first brake chamber 31 and the wheel cylinder part 40. The fifth line part 55 includes a fifth flow path 551 and a fifth valve unit 552. The fifth flow path 551 connects the first brake chamber 31 and the wheel cylinder part 40. The fifth flow path 551 may be directly connected to the first brake chamber 31 or connected to the third flow path 531 that connects the third valve unit 532 and the first brake chamber 31. The fifth valve unit 552 is disposed in the fifth flow path 551 and opens and closes the fifth flow path 551. The fifth flow path 551 is branched and connected to two wheel cylinder parts 40, and one or more fifth valve units 552 control the braking fluid. A fluid pressure sensor 920 that measures the pressure of the braking fluid may be provided on the fifth flow path 551 connecting a plurality of fifth valve units 552.

The sixth line part 56 connects a second brake chamber 32 and the wheel cylinder part 40. The sixth line part 56 includes a sixth flow path 561 and a sixth valve unit 562. The sixth flow path 561 connects the second brake chamber 32 and the wheel cylinder part 40. The sixth flow path 561 may be directly connected to the second brake chamber 32 or connected to the second flow path 521 that connects the second opening/closing valve unit 522 and the second brake chamber 32. The sixth valve unit 562 is disposed in the sixth flow path 561 and opens and closes the sixth flow path 561. The sixth flow path 561 is branched and connected to two wheel cylinder parts 40, and one or more sixth valve units 562 control the braking fluid.

In addition, the seventh line part 57 selectively connects the fifth line part 55 and the sixth line part 56. The eighth line part 58 connects the first recovery flow path 541 and the fifth flow path 551, and the ninth line part 59 connects the second recovery flow path 542 and the sixth flow path 561.

In a second embodiment of the present disclosure, the first valve unit 512 may be a normally closed valve, and the second opening/closing valve unit 522 and the third valve unit 532 may be normally open valves. That is, when the brake system is normally operated, when no separate control signal is transmitted, the first valve unit 512 may maintain the first flow path 511 in a closed state. In addition, the second opening/closing valve unit 522 and the third valve unit 532 may maintain the second flow path unit 521 and the third flow path unit 531 in open states, respectively (refer to FIG. 5).

When the pressure of the braking fluid pressurized by the pedal 90 is greater than or equal to the pressure of the braking fluid moving in the fifth line part 55, the emergency braking mode may be implemented. In addition, in the emergency braking situation, the pedal 90 may be pressurized at a set speed or higher. The set speed may be 450 mm/s.

The pressure of the braking fluid pressurized by the pedal 90 may be measured by the pedal pressure sensor 910. The pressure of the braking fluid moving in the fifth line part 55 may be measured by the fluid pressure sensor 920.

In the emergency braking mode, no separate control signal is transmitted to the first valve unit 512, the second opening/closing valve unit 522, and the third valve unit 532. That is, the first valve unit 512 closes the first flow path 511, the second opening/closing valve unit 522 opens the second flow path 521, and the third valve unit 532 maintains the third flow path 531 open. Accordingly, the braking fluid pressurized in the first backup chamber 21 may sequentially pass through the third flow path 531 and the fifth flow path 551 to reach the wheel cylinder part 40. In addition, the braking fluid pressurized in the second backup chamber 22 may sequentially pass through the second flow path 521 and the sixth flow path 561 to reach the wheel cylinder part 40 (refer to FIG. 7).

In the emergency braking mode, when the pressure of the braking fluid pressurized by the pedal 90 is lower than the pressure of the braking fluid moving in the fifth line part 55, the emergency braking mode may be switched to the normal braking mode. In the normal braking mode, the first valve unit 512 may be switched to open the first flow path 511 by a control signal. In addition, the second opening/closing valve unit 522 and the third valve unit 532 may be switched to close the second flow path 521 and the third flow path 531, respectively, by a control signal (refer to FIG. 6).

That is, in the second embodiment of the present disclosure, control can be performed on the first valve unit 512, the second opening/closing valve unit 522, and the third valve unit 532 in the normal braking mode.

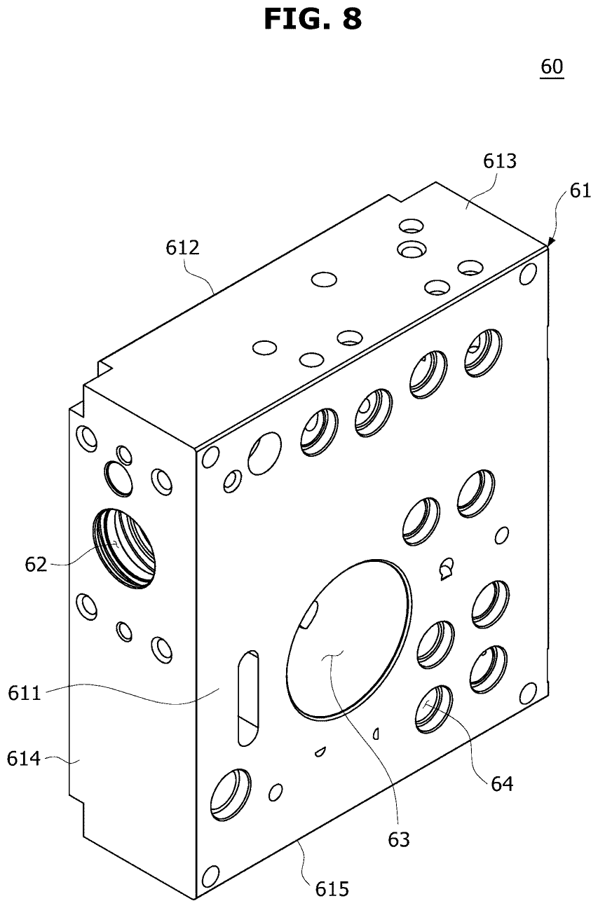

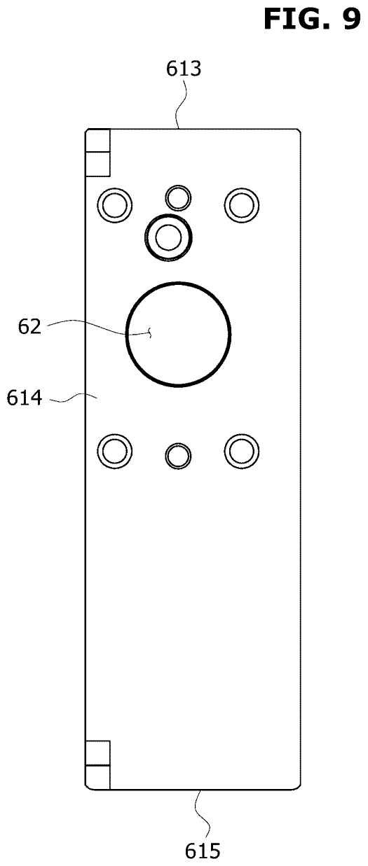

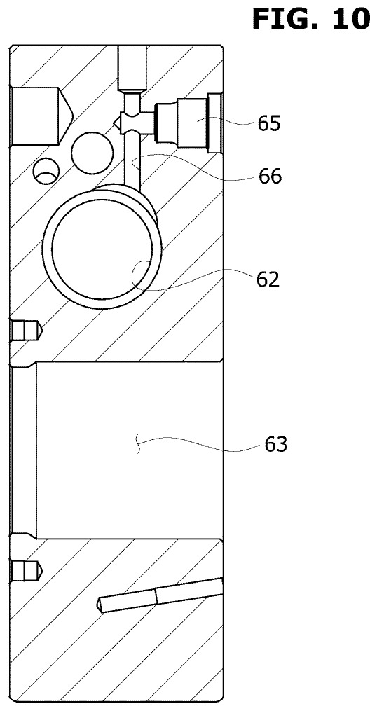

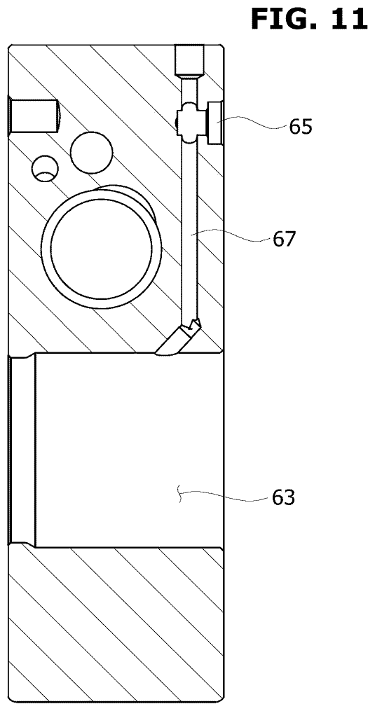

FIG. 8 is a perspective view schematically illustrating a block part according to an embodiment of the present disclosure. FIG. 9 is a side view schematically illustrating the block part according to an embodiment of the present disclosure. FIG. 10 schematically illustrates a backup flow path according to an embodiment of the present disclosure. FIG. 11 schematically illustrates a main brake flow path according to an embodiment of the present disclosure.

Referring to FIG. 8 to FIG. 11, the block part 60 according to an embodiment of the present disclosure includes a block body 61, a backup bore 62, a main brake bore 63, and may further include a block circuit part 64.

The block body 61 is formed in a square block made of a cutting-machined aluminum alloy manufactured by an extrusion molding method. The block body 61 includes a front portion 611, a rear portion 612, an upper portion 613, a side portion 614, and a bottom portion 615. The block body 61 may be disposed at an angle to the vehicle body.

The backup bore 62 is disposed in the block body 61 and provides an installation space for the backup part 20. For example, the backup bore 62 may be machined to cross the facing side portion 614.

The main brake bore 63 is disposed in the block body 61 and provides an installation space for the main brake part 30. For example, the main braking bore 63 may be machined to cross from the front portion 611 to the rear portion 612.

The block circuit part 64 is disposed in the block body 61 and guides the braking fluid. For example, the block circuit part 64 may be a line part 50 for the braking fluid, which is pressurized through the backup bore 62 and the main brake part 30, to move to the wheel cylinder part 40.

The main brake bore 63 is disposed below the backup bore 62. For example, the backup bore 62 may be disposed at an upper portion of the block body 61, and the main brake bore 63 may be disposed at a center or lower portion of the block body 61.

The backup bore 62 and the main brake bore 63 are disposed to intersect each other. For example, the backup bore 62 and the main brake bore 63 may be disposed to intersect each other with a height difference therebetween.

The block circuit part 64 according to an embodiment of the present disclosure includes a valve bore 65, a backup flow path 66, and a main brake flow path 67.

The valve bore 65 is disposed in the block body 61 and provides an installation space for the second opening/closing valve unit 522 or the third valve unit 532. In addition, a valve that opens and closes a path for guiding the braking fluid may be disposed at the valve bore 65. For example, the valve bore 65 may be machined from the front portion 611 toward the rear portion 612, or from the rear portion 612 toward the front portion 611. In addition, the valve bore 65 may be selectively machined on the upper portion 613, the side portion 614, and the bottom portion 615 depending on a design environment. The second opening/closing valve unit 522 or the third valve unit 532 may be inserted into the valve bore 65 to control the braking fluid passing through the valve bore 65. A plurality of valve bores 65 may be arranged in the block body 61, and the following description is limited to those arranged on the path of the braking fluid moving between the backup part 20 and the main body part 30.

The backup flow path 66 connects the backup bore 62 and the valve bore 65. For example, the backup flow path 66 may have a lower portion connected to the backup bore 62 and an upper portion connected to the valve bore 65.

The main brake flow path 67 connects the valve bore 65 and the main brake bore 63. For example, an upper end of the main brake flow path 67 may be connected to the valve bore 65, and a lower end may be connected to the main brake flow path 63.

The valve bore 65 is disposed over the backup bore 62. For example, the backup bore 62 may have a hole shape penetrating the side portion 614, and the valve bore 65 machined in the front portion 611 may be disposed over the backup bore 62.

The operation of the electronic hydraulic brake device according to an embodiment of the present disclosure having the above-described configuration is described as follows.

When a brake system operates normally, when the pedal 90 is pressurized while the vehicle is driving, the main brake part 30 is driven according to a pedal pressure level sensed by the pedal of the backup part 20. The braking fluid pressurized in the main brake part 30 is supplied to the wheel cylinder part 40 to perform vehicle braking.

The first valve unit 512 opens and closes the first flow path 511 that connects the second storage chamber 12 and the second backup chamber 22. The second opening/closing valve unit 522 opens and closes the second flow path 521 that connects the second backup chamber 22 and the second brake chamber 32. The third valve unit 532 opens and closes the third flow path 531 that connects the first backup chamber 21 and the first brake chamber 31.

In a first embodiment of the present disclosure, the first valve unit 512 is a normally open valve, and the second opening/closing valve unit 522 and the third valve unit 532 are normally closed valves. That is, when the brake system is normally operated, when no separate control signal is transmitted, the first valve unit 512 maintains the first flow path 511 in an open state. In addition, the second opening/closing valve unit 522 and the third valve unit 532 maintain the second flow path 521 and the third flow path 531 in a closed state, respectively.

In the state, when the pressure of the braking fluid pressurized by the pedal 90 is greater than or equal to the pressure of the braking fluid moving in the fifth line part 55, emergency braking mode is implemented. In addition, the emergency braking mode may also be implemented when the pedal 90 has a pedal effort speed greater than or equal to 450 mm/s.

In the emergency braking mode, the first valve unit 512 closes the first flow path 511, the second valve unit 522 opens the second flow path 521, and the third valve unit 532 opens the third flow path 531. As a result, the braking fluid pressurized in the first backup chamber 21 passes through the third flow path 531 and the fifth flow path 551 sequentially to reach the wheel cylinder part 40, thereby enabling emergency braking of the vehicle. In addition, the braking fluid pressurized in the second backup chamber 22 passes through the second flow path 521 and the sixth flow path 561 sequentially to reach the wheel cylinder part 40, thereby enabling emergency braking of the vehicle.

In the emergency braking mode, when the pressure of the braking fluid pressurized by the pedal 90 is lower than the pressure of the braking fluid moving in the fifth line part 55, braking mode is switched from the emergency braking mode to the normal braking mode.

In a second embodiment of the present disclosure, the first valve unit 512 is a normally closed valve, and the second opening/closing valve unit 522 and the third valve unit 532 are normally open valves. That is, when the brake system is normally operated, when no separate control signal is transmitted, the first valve unit 512 maintains the first flow path 511 in a closed state. In addition, the second opening/closing valve unit 522 and the third valve unit 532 maintain the second flow path 521 and the third flow path 531 in an open state, respectively.

In the state, when the pressure of the braking fluid pressurized by the pedal 90 is greater than or equal to the pressure of the braking fluid moving in the fifth line part 55, the emergency braking mode is implemented. In addition, the emergency braking mode may also be implemented when the pedal 90 has a pedal effort speed greater than or equal to 450 mm/s.

In the emergency braking mode, the first valve unit 512 maintains the first flow path 511 in a closed state, and the second valve unit 522 and the third valve unit 532 maintains the second flow path 521 and the third flow path 531 in an open state, respectively. As a result, the braking fluid pressurized in the first backup chamber 21 passes through the third flow path 531 and the fifth flow path 551 sequentially to reach the wheel cylinder part 40, so that the emergency braking of the vehicle can be performed. In addition, the braking fluid pressurized in the second backup chamber 22 passes through the second flow path 521 and the sixth flow path 561 sequentially to reach the wheel cylinder part 40, so that the emergency braking of the vehicle can be performed.

In the emergency braking mode, when the pressure of the braking fluid pressurized by the pedal 90 is lower than the pressure of the braking fluid moving in the fifth line part 55, the mode is switched from the emergency braking mode to the normal braking mode.

In the electronic hydraulic brake device 1 according to an embodiment of the present disclosure, in a normal braking situation, the backup part 20 provides the pedal effort of the pedal 90 and the main driving part 30 is driven to correspond to the pedal effort of the pedal 90 so that the braking fluid may be supplied to the wheel cylinder part 40.

In the electronic hydraulic brake device 1 according to an embodiment of the present disclosure, the pressure of the braking fluid pressurized by the pedal 90 in an emergency braking situation is higher than the pressure of the braking fluid pressurized by the driving of the main drive part 30, so that the braking fluid increased by the pedal 90 may be supplied to the wheel cylinder part 40 first. Accordingly, braking responsiveness may be improved and a braking distance may be reduced.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. An electronic hydraulic brake device comprising:
a storage part that includes a first storage chamber and a second storage chamber and stores braking fluid;
a backup part that includes a first backup chamber and a second backup chamber, is engaged to a pedal and is pressurized by the pedal;
a main brake part that includes a first brake chamber and a second brake chamber, is engaged to a motor and is driven by the motor to provide the braking fluid;
a wheel cylinder part that provides braking force by the supplied braking fluid; and
a line part that connects the storage part, the backup part, the main brake part, and the wheel cylinder part and guides the braking fluid,
wherein in an emergency braking situation, the braking fluid of the backup part pressurized by the pedal is supplied to the wheel cylinder part before the braking fluid is pressurized by the main brake part.

2. The electronic hydraulic brake device of claim 1, wherein the line part comprises:
a first line part that connects the second storage chamber and the second backup chamber;
a second line part that connects the second backup chamber and the second brake chamber;
a third line part that connects the first storage chamber and the first brake chamber;
a fourth line part that connects the first storage part and the wheel cylinder part;
a fifth line part that connects the first brake chamber and the wheel cylinder part; and
a sixth line part that connects the second brake chamber and the wheel cylinder part.

3. The electronic hydraulic brake device of claim 2, wherein the line part further comprises a seventh line part selectively connecting the fifth line part and the sixth line part.

4. The electronic hydraulic brake device of claim 2, wherein the fourth line part comprises:
a first recovery flow path connecting the first storage chamber and the fifth line part; and
a second recovery flow path connecting the second storage chamber and the sixth line part.

5. The electronic hydraulic brake device of claim 4, wherein the line part further comprises an eighth line part connecting the first recovery flow path and the fifth flow path.

6. The electronic hydraulic brake device of claim 4, wherein the line part further comprises a ninth line part connecting the second recovery flow path and the sixth flow path.

7. The electronic hydraulic brake device of claim 2, wherein the first line part comprises:
a first flow path that connects the second storage chamber and the second backup chamber; and
a first valve unit that is disposed in the first flow path and configured to open and close the first flow path.

8. The electronic hydraulic brake device of claim 7, wherein the second line part comprises:
a second flow path that connects the second backup chamber and the second brake chamber;
a second opening/closing valve unit that is disposed in the second flow path and opens and closes the second flow path; and
a second check valve unit that is disposed in the second opening/closing valve unit and passes the braking fluid of a set pressure or higher.

9. The electronic hydraulic brake device of claim 8, wherein the third line part comprises:
a third flow path that connects the first backup chamber and the first brake chamber; and
a third valve unit disposed in the third flow path and opens and closes the third flow path.

10. The electronic hydraulic brake device of claim 8, wherein the fifth line part comprises:
a fifth flow path that connects the first brake chamber and the wheel cylinder part; and
a fifth valve unit that is disposed in the fifth flow path and opens and closes the fifth flow path.

11. The electronic hydraulic brake device of claim 8, wherein the sixth line part comprises:
a sixth flow path that connects the second brake chamber and the wheel cylinder part; and
a sixth valve unit that is disposed in the sixth flow path and opens and closes the sixth flow path.

12. The electronic hydraulic brake device of claim 9, wherein the first valve unit is a normally open valve, and the second opening/closing valve unit and the third valve unit are normally closed valves.

13. The electronic hydraulic brake device of claim 12, wherein based on that a pressure of the braking fluid pressurized by the pedal is greater than or equal to a pressure of the braking fluid moving in the fifth line part,
the first valve unit closes the first flow path,
the second opening/closing valve unit opens the second flow path, and
the third valve unit opens the third flow path.

14. The electronic hydraulic brake device of claim 13, wherein based on that the pressure of the braking fluid pressurized by the pedal is lower than the pressure of the braking fluid moving in the fifth line part,
the first valve section opens the first flow path,
the second opening/closing valve unit closes the second flow path, and
the third valve unit closes the third flow path.

15. The electronic hydraulic brake device of claim 9, wherein the first valve unit is a normally closed valve, and the second valve unit and the third valve unit are normally open valves.

16. The electronic hydraulic brake device of claim 15, wherein based on that a pressure of the braking fluid pressurized by the pedal is greater than or equal to a pressure of the braking fluid moving in the fifth line part,
the first valve unit closes the first flow path,
the second opening/closing valve unit opens the second flow path, and
the third valve unit opens the third flow path.

17. The electronic hydraulic brake device of claim 15, wherein based on that the pressure of the braking fluid pressurized by the pedal is lower than the pressure of the braking fluid moving in the fifth line part,
the first valve unit opens the first flow path,
the second opening/closing valve unit closes the second flow path, and
the third valve unit closes the third flow path.

18. The electronic hydraulic brake device of claim 1, further comprising a block part in which the backup part and the main brake part are settled and the line part is disposed to guide the braking fluid.

19. The electronic hydraulic brake device of claim 18, wherein the block part comprises:
a block body;
a backup bore disposed in the block body and including an installation space for the backup part; and
a main brake bore disposed in the block body and including an installation space for the main brake part.
